(19) United States
(12) Patent Application Publication
(10) Pub. No.: US 2016/0139370 A1
(43) Pub. Date: May 19, 2016

(54) PHOTOGRAPHING LENS OPTICAL SYSTEM

(71) Applicant: KOLEN CO., LTD., Gyeonggi-do (KR)

(72) Inventors: Jong Jin Lee, Seoul (KR); Chan Goo Kang, Gyeonggi-do (KR)

(21) Appl. No.: 14/939,054

(22) Filed: Nov. 12, 2015

(30) Foreign Application Priority Data
Nov. 18, 2014 (KR) 10-2014-0160874

(51) Int. Cl. G02B 13/00; G02B 27/00; G02B 5/20; G02B 9/60; H04N 5/225; G02B 1/04

(52) U.S. Cl. CPC G02B 13/0045; H04N 5/2254; G02B 1/041; G02B 5/208; G02B 9/60; G02B 27/0025

(57) ABSTRACT

Provided is a photographing lens optical system achieving high performance with low expenses. The lens optical system includes a first lens, a second lens, a third lens, and a fourth lens sequentially arranged between an object and an image sensor on which an image of the object is formed from the object side, and an aperture disposed between the object and the first lens, wherein the first to fifth lenses respectively have positive, negative, negative, positive, and negative refractive powers.

### CROSS-REFERENCE TO RELATED APPLICATION

This application claims the benefit of Korean Patent Application No. 10-2014-0160874, filed on Nov. 18, 2014, in the Korean Intellectual Property Office, the disclosure of which is incorporated herein in its entirety by reference.

### BACKGROUND

1. Field

One or more exemplary embodiments relate to an optical device, and more particularly, to a lens optical system applied to a camera.

2. Description of the Related Art

Cameras having solid state imaging devices such as a charge-coupled device (CCD) and a complementary metal-oxide semiconductor (CMOS) image sensor applied thereto have been widely distributed.

Since a pixel integration degree of a solid state imaging device increases, a resolution is being improved rapidly. In addition, the performance of a lens optical system has been greatly improved, and thus, cameras may have high performance, small sizes, and lightweight.

In a lens optical system of a general small camera, e.g., a camera for a mobile phone, an optical system including a plurality of lenses has one or more glass lenses. However, a glass lens has high unit manufacturing costs, and makes it difficult to miniaturize the lens optical system due to limitations in forming/processing the glass lens.

Therefore, a lens optical system capable of achieving high performance/high resolution while addressing the problems of a glass lens is required, wherein the optical lens system has a small size and low unit manufacturing costs.

### SUMMARY

One or more exemplary embodiments include a lens optical system that is manufactured with low manufacturing costs, is small in size, and lightweight.

One or more exemplary embodiments include a lens optical system of high performances, which is suitable for a camera of high resolution.

Additional aspects will be set forth in part in the description which follows and, in part, will be apparent from the description, or may be learned by practice of the presented embodiments.

According to one or more exemplary embodiments, a lens optical system includes: first to fifth lenses sequentially arranged along a light path between an object and an image sensor on which an image of the object is formed, wherein the first lens has a positive refractive power, the second lens has a negative refractive power, the third lens has a negative refractive power, the fourth lens has a positive refractive power, the fifth lens has a negative refractive power, and the lens optical system satisfies the following Conditions 1 to 3,

60<FOV<90, <Condition 1>

where FOV denotes a diagonal viewing angle of the lens optical system,

0.5<AL/TTL<1.2, <Condition 2>

where AL denotes a distance from the aperture to the image sensor, and TTL denotes an optical distance from a center of an incident surface of the first lens to the image sensor,

0.5<TTL/ImgH<1.5, <Condition 3>

where ImgH denotes a diagonal length of an effective pixel region of the image sensor.

An incident surface of the first lens may be convex toward the object and an exit surface of the first lens may be flat.

At least one of the first to fifth lenses may be an aspheric lens.

At least one of an incident surface and an exit surface of at least one of the first to fifth lenses may be an aspherical surface.

At least one of the first to fifth lenses may be a plastic lens.

The first to fifth lenses may be aberration correcting lenses.

The aperture may be disposed between the object and the first lens.

The lens optical system may further include an infrared ray blocking unit between the object and the image sensor.

The infrared ray blocking unit may be disposed between the fifth lens and the image sensor.

According to one or more exemplary embodiments, a lens optical system includes a first lens, a second lens, a third lens, and a fourth lens sequentially arranged between an object and an image sensor on which an image of the object is formed from the object side, and an aperture disposed between the object and the first lens, wherein the first to fifth lenses respectively have positive, negative, negative, positive, and negative refractive powers, and the lens optical system satisfies at least one of following Conditions 1 to 3,

60<FOV<90, <Condition 1>

where FOV denotes a diagonal viewing angle of the lens optical system,

0.5<AL/TTL<1.2, <Condition 2>

where AL denotes a distance from the aperture to the image sensor, and TTL denotes an optical distance from a center of an incident surface of the first lens to the image sensor,

0.5<TTL/ImgH<1.5, <Condition 3>

where ImgH denotes a diagonal length of an effective pixel region of the image sensor.

At least one of third to fifth lenses may be a meniscus lens.

An incident surface of the first lens may be convex toward the object, and an exit surface of the first lens may be flat.

The second lens may be concave from the image sensor.

The third lens may be convex toward the image sensor.

The fourth lens may be convex toward the image sensor.

An incident surface of the fifth lens may have one or more inflection points from a center portion to an edge.

At least one of the first to fifth lenses may be an aspheric lens.

At least one of an incident surface and an exit surface of at least one of the first to fifth lenses may be an aspherical surface.

### BRIEF DESCRIPTION OF THE DRAWINGS

These and/or other aspects will become apparent and more readily appreciated from the following description of the embodiments, taken in conjunction with the accompanying drawings in which:

FIGS. 1 to 3 are cross-sectional views illustrating arrangements of main elements of a lens optical system according to one or more exemplary embodiments;

FIG. 4 illustrates longitudinal spherical aberrations, astigmatic field curvatures, and distortion of a lens optical system, according to an exemplary embodiment;

FIG. 5 illustrates longitudinal spherical aberrations, astigmatic field curvatures, and distortion of a lens optical system, according to an exemplary embodiment; and

FIG. 6 illustrates longitudinal spherical aberrations, astigmatic field curvatures, and distortion of a lens optical system, according to an exemplary embodiment.

### DETAILED DESCRIPTION

Reference will now be made in detail to embodiments, examples of which are illustrated in the accompanying drawings, wherein like reference numerals refer to like elements throughout. Expressions such as “at least one of,” when preceding a list of elements, modify the entire list of elements and do not modify the individual elements of the list.

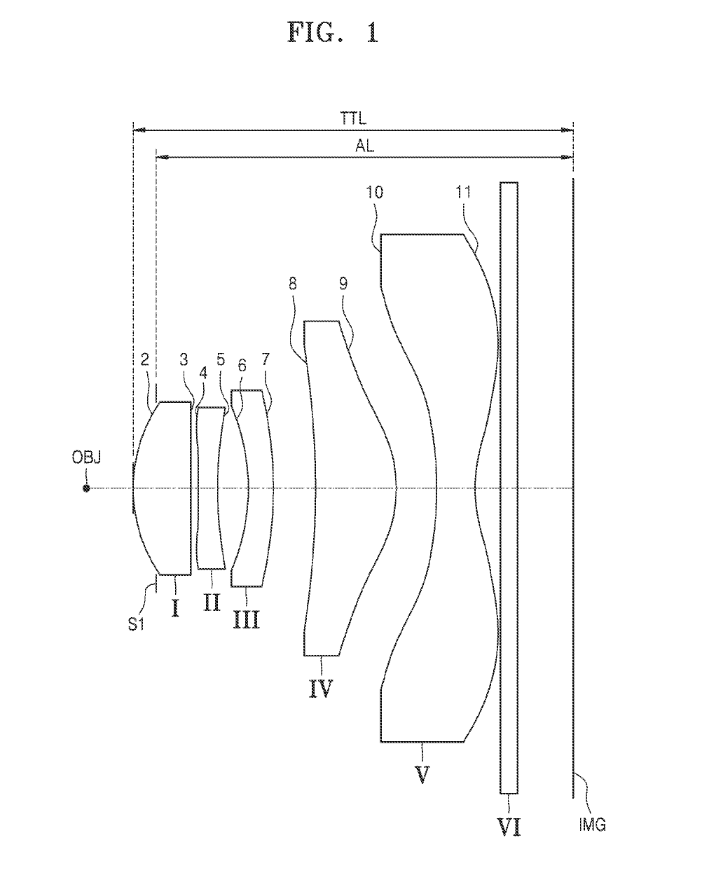

FIGS. 1 to 3 are cross-sectional views of a lens optical system according to one or more exemplary embodiments.

Referring to FIGS. 1 to 3, the lens optical system according to one or more exemplary embodiments includes a first lens I, a second lens II, a third lens III, a fourth lens IV, and a fifth lens V that are sequentially arranged between the object OBJ and an image sensor IMG on which an image of the object OBJ is formed, from an object OBJ side.

The first lens I may have a positive (+) refractive power, and may be convex toward the object OBJ. An incident surface 2 of the first lens I may be convex toward the object OBJ, and an exit surface 3 of the first lens I may be flat.

The second lens II may have a negative (−) refractive power. An exit surface 5 of the second lens II may be concave from the image sensor IMG, and an incident surface 4 of the second lens II may be concave from the object OBJ side.

The third lens III may have a negative (−) refractive power. In detail, an incident surface 6 of the third lens III may be concave from the object OBJ, and an exit surface 7 of the third lens III may convex toward the image sensor IMG side.

The fourth lens IV may have a positive (+) refractive power. In detail, an incident surface 8 of the fourth lens IV is concave from the object OBJ and an exit surface 9 of the fourth lens IV may be convex toward the image sensor IMG side.

The fifth lens V that is the last lens of the lens optical system may have a negative (−) refractive power and convex toward the image sensor IMG. Here, an incident surface 10 of the fifth lens V is convex toward the object OBJ side, and an exit surface 11 of the fifth lens V may be convex toward the image sensor IMG side.

At least one of the incident surface 10 and the exit surface 11 of the fifth lens V may be an aspherical surface. For example, the incident surface 10 of the fifth lens V may be an aspherical surface having one or two inflection points from a center portion thereof to an edge. In detail, the exit surface 11 of the fifth lens V may be concave at a center portion thereof and then may be convex toward the image sensor IMG side to an edge.

At least one of the first to fifth lenses I to V may be an aspherical lens. That is, at least one of the incident surface 2, 4, 6, 8, or 10 and the exit surface 3, 5, 7, 9, or 11 of at least one of the first to fifth lenses I to V may be aspheric.

According to another exemplary embodiment, the incident surface 2, 4, 6, 8, and 10 of the first to fifth lenses I to V and the exit surface 5, 7, 9, and 11 of the second to fifth lenses II to V may be all aspheric surfaces.

In addition, an aperture S1 and an infrared ray blocking unit VI may be further disposed between the object OBJ and the image sensor IMG. The aperture S1 may be disposed between the object OBJ and the first lens I. That is, the aperture S1 may be adjacent to the exit surface 4* of the second lens II.

The infrared ray blocking unit VI may be disposed between the fifth lens V and the image sensor IMG. The infrared ray blocking unit VI may be an infrared ray blocking filter. The locations of the aperture S1 and the infrared ray blocking unit VI may vary.

In FIGS. 1 to 3, a total track length (TTL) is a distance from a center of the incident surface 1 of the first lens I to the image sensor IMG, that is, a total length of the lens optical system. In addition, AL denotes a distance from the aperture S1 to the image sensor IMG.

The lens optical system described above according to the exemplary embodiments may satisfy at least one of Conditions 1 to 3 below.

60<FOV<90 (1)

Here, FOV denotes a diagonal viewing angle of the optical system. The viewing angle is restricted as above in order to configure a wide angle lens system of a high resolution.

0.5<AL/TTL1.2 (2)

Here, AL denotes a distance from the aperture S1 to the image sensor IMG, and TTL denotes an optical distance from the center of the incident surface 1 of the first lens I to the image sensor IMG. The above condition determines a location of the aperture S1. As such, the aperture S1 is disposed in front of the first lens I in the wide angle lens structure so that an optimized lens system may be obtained.

0.5<TTL/ImgH<1.5 (3)

Here, ImgH is a diagonal length of an effective pixel area of the image sensor IMG. In the above condition, toward the minimum value, the optical system becomes slim, but it is difficult to correct aberration. In addition, toward the maximum value, it is easy to correct the aberrations, but it is difficult to form a compact optical system.

In the above exemplary embodiments (EMB1 to EMB3), Table 1 shows values of the above conditions EQU1 to EQU3.

TABLE 1

| | FOV | EQU1 | AL | TTL | EQU2 | ImgH | EQU3 |
|---|---|---|---|---|---|---|---|
| EMB 1 | 75.730 | 75.730 | 4.989 | 5.270 | 0.947 | 6.856 | 0.769 |
| EMB 2 | 76.076 | 76.076 | 4.996 | 5.261 | 0.950 | 6.856 | 0.767 |
| EMB 3 | 75.706 | 75.706 | 5.029 | 5.299 | 0.949 | 6.856 | 0.773 |

As shown in Table 1, the exemplary embodiments EMB1 to EMB3 all satisfy the above conditions 1 to 3.

In the lens optical system having the above described structure according to the one or more exemplary embodiments, the first to fifth lenses I to V may be formed of plastic in consideration of shapes and dimensions thereof. That is, all the first to fifth lenses I to V may be plastic lenses.

If a glass lens is used, a lens optical system not only has high manufacturing unit costs, but also is difficult to miniaturize due to restrictions on forming/processing of the glass lens. However, since the first to fifth lenses I to V may be formed of plastic, manufacturing unit costs may be decreased and a lens optical system may be miniaturized.

However, the material forming the first to fifth lenses I to V in the exemplary embodiments is not limited to plastic. If necessary, at least one of the first to fifth lenses I to V may be formed of glass.

One or more exemplary embodiments #1 to #3 will be described in detail below with reference to lens data and accompanying drawings.

Table 2 to Table 4 below show a curvature radius, a lens thickness or a distance between lenses, a refractive index, and an Abbe's number of each lens included in the lens optical systems illustrated in FIGS. 1 to 3.

In Table 2 to Table 4, S denotes a number of a lens surface, R denotes a curvature radius, D denotes a lens thickness, a lens interval, or an interval between adjacent elements, Nd denotes a refractive index of a lens measured by using a d-line, and Vd denotes an Abbe's number of a lens with respect to a d-line. A mark ‘*’ besides a lens surface number denotes that a lens surface is aspheric. Also, a unit of values of R and D is mm.

TABLE 2

| #1 | S | R | T | Nd | Vd |
|---|---|---|---|---|---|
| | S1 | Infinity | −0.2813 | | |
| I | 2* | 1.6672 | 0.7002 | 1.534 | 55.856 |
| | 3 | Infinity | 0.0800 | | |
| II | 4* | −12.1227 | 0.2300 | 1.648 | 22.436 |
| | 5* | 5.6207 | 0.3672 | | |
| III | 6* | −173.8447 | 0.3000 | 1.648 | 22.436 |
| | 7* | 76.1732 | 0.5083 | | |
| IV | 8* | −7.0403 | 0.9692 | 1.546 | 55.093 |
| | 9* | −1.3323 | 0.4755 | | |
| V | 11* | −8.0402 | 0.4795 | 1.534 | 55.856 |
| | 12* | 1.5152 | 0.3000 | | |

EMB1: FNo. = 2.2147/f = 4.3736 mm

TABLE 3

| #2 | S | R | T | Nd | Vd |
|---|---|---|---|---|---|
| | S1 | Infinity | −0.2647 | | |
| I | 2* | 1.6608 | 0.6816 | 1.534 | 55.856 |
| | 3 | Infinity | 0.0800 | | |
| II | 4* | −9.9398 | 0.2212 | 1.648 | 22.434 |
| | 5* | 6.5501 | 0.3814 | | |
| III | 6* | −90.8890 | 0.2860 | 1.648 | 27.434 |
| | 7* | 79.3890 | 0.4958 | | |
| IV | 8* | −7.1867 | 0.9859 | 1.546 | 56.093 |
| | 9* | −1.3860 | 0.4774 | | |
| V | 10* | −14.8458 | 0.4949 | 1.534 | 55.856 |
| | 11* | 1.4959 | 0.3000 | | |

EMB2: FNo. = 2.2147/f = 4.2912 mm

TABLE 4

| #3 | S | R | T | Nd | Vd |
|---|---|---|---|---|---|
| | S1 | Infinity | −0.2694 | | |
| I | 2* | 1.6668 | 0.7102 | 1.534 | 55.856 |
| | 3 | Infinity | 0.0800 | | |
| II | 4* | −9.2447 | 0.2091 | 1.648 | 22.436 |
| | 5* | 7.3372 | 0.3970 | | |
| III | 6* | −31.8971 | 0.2821 | 1.648 | 22.436 |
| | 7* | −606.3811 | 0.4771 | | |
| IV | 8* | −6.7003 | 1.0034 | 1.546 | 56.093 |
| | 9* | −1.3836 | 0.4674 | | |
| V | 10* | −17.8610 | 0.5120 | 1.534 | 55.856 |
| | 11* | 1.4794 | 0.3000 | | |

EMB3: FNo. = 2.2147/f = 4.3182 mm

In addition, the aspheric surface of the each lens in the lens optical system according to the above exemplary embodiments satisfies the aspheric formula 4.

$$x = \frac{{c}^{′} {y}^{2}}{1 + \sqrt{1 - ( K + 1 ) {c}^{′ 2} {y}^{2}}} + {Ay}^{4} + {By}^{6} + {Cy}^{8} + {Dy}^{10} + {Ey}^{12} \qquad ( 4 )$$

Here, x denotes a distance from an apex of a lens in an optical axis direction, H denotes a distance in a direction perpendicular to an optical axis, c′ denotes a reciprocal number of a curvature radius at an apex of a lens (=1/r), K denotes a conic constant, and A, B, C, D, and E each denote an aspheric coefficient.

Tables 5 to 7 below show aspheric coefficients of aspheric surfaces respectively in the lens optical systems according to the exemplary embodiments illustrated in FIGS. 1 to 3. In other words, Tables 5 to 7 show aspheric coefficients of the incident surfaces 1*, 3*, 6*, and 8* and the exit surfaces 2*, 4*, 7*, 9*, and 11* of Tables 2 to 5.

TABLE 5

| S | K | A | B | C | D | E | F |
|---|---|---|---|---|---|---|---|
| 2 | −0.0819 | 0.0077 | 0.0043 | −0.0239 | 0.0332 | −0.0194 | — |
| 4 | 0.0000 | 0.0108 | 0.0511 | −0.0317 | 0.0168 | 0.0148 | — |
| 5 | −1.0033 | −0.0204 | 0.0660 | −0.0338 | −0.0336 | 0.0459 | — |
| 6 | 0.0000 | −0.2032 | −0.0319 | −0.0368 | −0.0100 | 0.0338 | — |
| 7 | 0.0000 | −0.1255 | −0.0224 | 0.0213 | −0.0086 | 0.0168 | — |
| 8 | −81.8241 | −0.0131 | 0.0102 | −0.0114 | 0.0090 | −0.0025 | 0.0001 |
| 9 | −2.8395 | −0.0023 | −0.0097 | 0.0105 | −0.0022 | 0.0003 | −0.0001 |
| 10 | −25.1725 | −0.0866 | 0.0259 | −0.0027 | −0.0002 | 0.0001 | 0.0000 |
| 11 | −6.9265 | −0.0576 | 0.0190 | −0.0042 | 0.0005 | −0.0000 | −0.0000 |

TABLE 6

| S | K | A | B | C | D | E | F |
|---|---|---|---|---|---|---|---|
| 2 | −0.0678 | 0.0066 | 0.0092 | −0.0240 | 0.0316 | −0.0184 | — |
| 4 | 0.0000 | 0.0094 | 0.0505 | −0.0350 | 0.0143 | 0.0162 | — |
| 5 | 5.6642 | −0.0155 | 0.0596 | −0.0324 | −0.0305 | 0.0445 | — |
| 6 | 0.0000 | −0.1989 | −0.0269 | −0.0365 | −0.0103 | 0.0369 | — |
| 7 | 0.0000 | −0.1259 | −0.0220 | 0.0211 | −0.0089 | 0.0167 | — |
| 8 | −85.3964 | −0.0141 | 0.0102 | −0.0114 | 0.0089 | −0.0025 | 0.0001 |
| 9 | −2.8596 | −0.0020 | −0.0099 | 0.0104 | −0.0022 | 0.0003 | −0.0001 |
| 10 | −4.2955 | −0.0880 | 0.0257 | −0.0027 | −0.0002 | 0.0001 | 0.0000 |
| 11 | −6.2349 | −0.0574 | 0.0190 | −0.0042 | 0.0005 | −0.0000 | −0.0000 |

TABLE 7

| S | K | A | B | C | D | E | F |
|---|---|---|---|---|---|---|---|
| 3 | −0.0663 | 0.0059 | 0.0118 | −0.0249 | 0.0307 | −0.0165 | — |
| 5 | 0.0000 | 0.0091 | 0.0493 | −0.0375 | 0.0132 | 0.0168 | — |
| 6 | 9.3982 | −0.0127 | 0.0544 | −0.0310 | −0.0296 | 0.0418 | — |
| 7 | 0.0000 | −0.1984 | −0.0259 | −0.0378 | −0.0122 | 0.0371 | — |
| 8 | 0.0000 | −0.1256 | −0.0218 | 0.0203 | −0.0095 | 0.0165 | — |
| 9 | −79.2001 | −0.0150 | 0.0103 | −0.0115 | 0.0089 | −0.0025 | 0.0001 |
| 10 | −2.8505 | −0.0018 | −0.0100 | 0.0104 | −0.0022 | 0.0003 | −0.0001 |
| 11 | 10.4602 | −0.0885 | 0.0257 | −0.0027 | −0.0002 | 0.0001 | 0.0000 |
| 12 | −6.1398 | −0.0576 | 0.0189 | −0.0042 | 0.0005 | −0.0000 | −0.0000 |

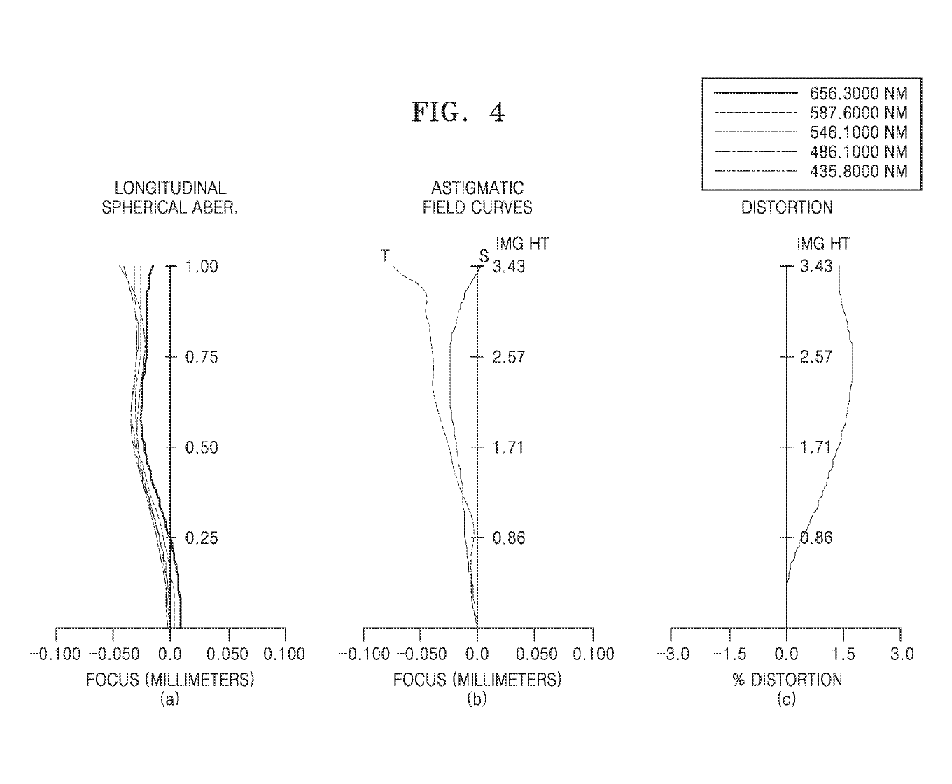

FIG. 4 illustrates (a) longitudinal spherical aberrations, (b) astigmatic field curvatures, and (c) distortion of the lens optical system of FIG. 1, that is, the lens optical system having the values of Table 2. In FIGS. 4 to 6, IMG HT denotes an image height.

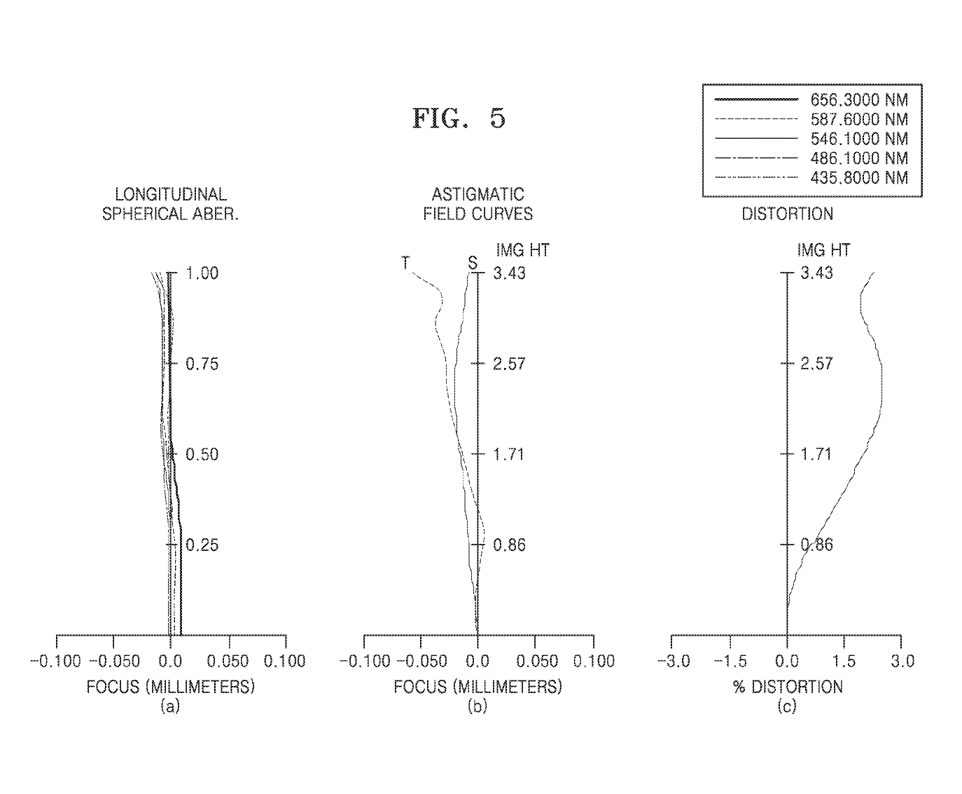

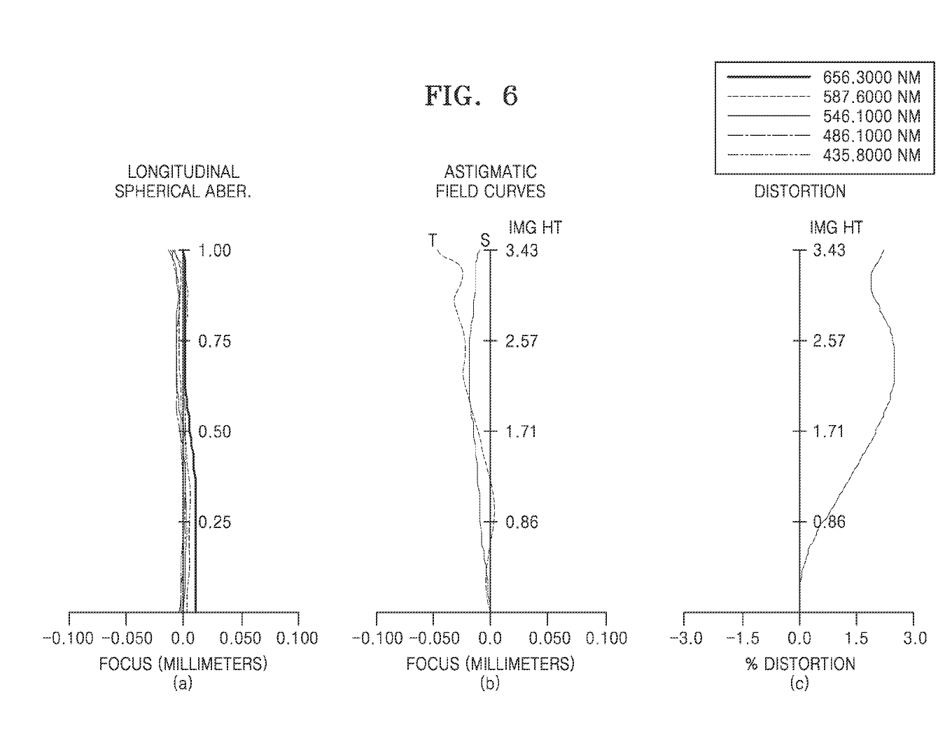

In FIG. 4, (a) shows spherical aberrations of the lens optical system with respect to light of various wavelengths, (b) shows astigmatic field curvatures of the lens optical system, that is, tangential field curvature T and sagittal field curvature S. Wavelengths of light used to obtain data of (a) were 656.0000 nm, 588.0000 nm, 546.0000 nm, 486.0000 nm, and 436.0000 nm. Wavelength of light used to obtain data of (b) and (c) was 486.0000 nm. The same wavelengths are also used to obtain data shown in FIGS. 5 and 6.

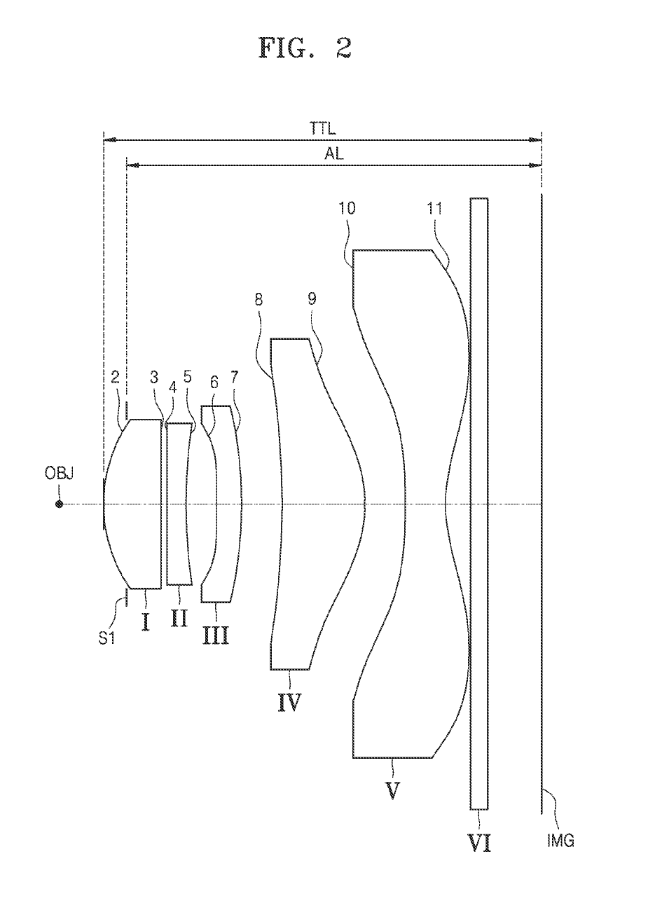

In FIGS. 5, (a), (b), and (c) respectively show longitudinal spherical aberrations, astigmatic field curvatures, and distortion of the lens optical system according to the exemplary embodiment illustrated in FIG. 2, that is, the lens optical system having values shown in Table 3.

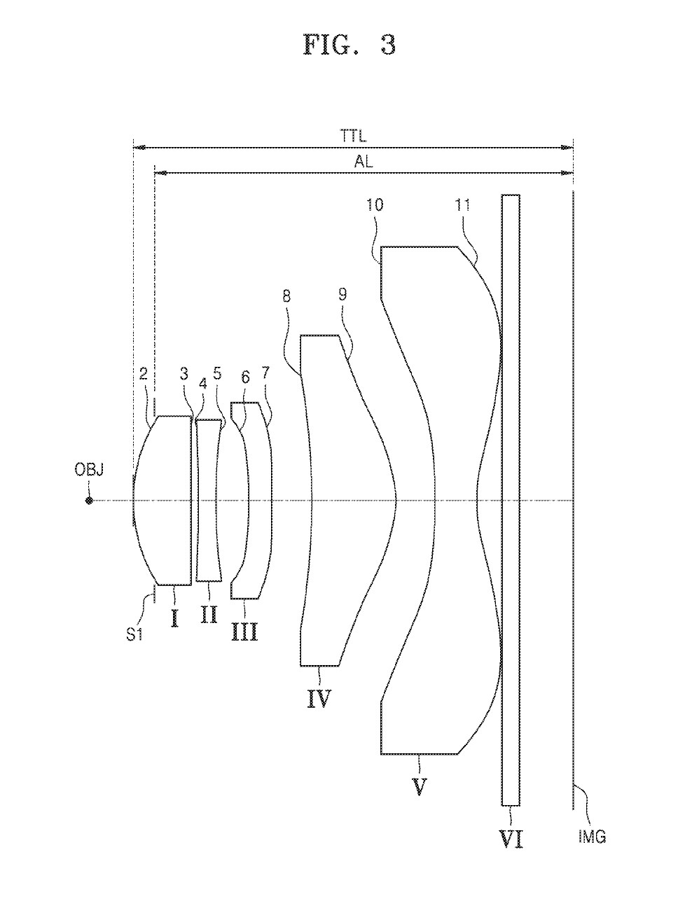

In FIGS. 6, (a), (b), and (c) respectively show longitudinal spherical aberrations, astigmatic field curvatures, and distortion of the lens optical system according to the exemplary embodiment illustrated in FIG. 3, that is, the lens optical system having values shown in Table 4.

As described above, the lens optical system according to the exemplary embodiments include the first to fifth lenses I to V respectively having the positive (+), negative (−), negative (−), positive (+), and negative (−) refractive powers and arranged sequentially from the object OBJ to the image sensor IMG, and may satisfy at least one of Conditions 1 to 3.

Such lens optical systems may have a wide viewing angle and a short total length, and may easily correct various aberrations. Therefore, the lens optical system according to the exemplary embodiments may obtain high performances and high resolution with a small size and a wide viewing angle.

In particular, if the incident surface 10* of the fifth lens V is an aspheric surface having at least one inflection point from a center portion thereof to the edge, in particular, two or more inflection points from the center portion to the edge, various aberrations may be easily corrected by using the fifth lens V, and an exit angle of a chief ray may be reduced to prevent vignetting.

Also, since the first to fifth lenses I to V are formed of plastic and opposite surfaces (incident surface and exit surface) of each of the lenses I to V is formed to be aspheric, the lens optical system having high performances with a compact size may be formed with less expenses than that of using the glass lens.

According to the one or more exemplary embodiments, a lens optical system may be small in size and have lightweight, and obtain high performances and high resolution. In particular, the lens optical system according to the exemplary embodiments includes the first to fifth lenses I to V respectively having positive, negative, negative, positive, and negative refractive powers and arranged sequentially from the object to the image sensor, and satisfies at least one of the Conditions 1 to 3. The first lens having the positive refractive power has a strong power, and the negative refractive power is distributed to the second and third lenses.

Such above lens optical system has a wide viewing angle and a short total length, and corrects various aberrations easily, and thus, is suitable for the high performance and small-sized camera. In particular, if the incident surface of the fifth lens is an aspheric surface having one or more inflection points from the center portion to the edge, the various aberrations may be easily corrected by using the fifth lens.

In addition, since at least one of the first to fifth lenses is formed of plastic and opposite surfaces of each lens (incident surface and exit surface) are formed to be aspheric surfaces, the lens optical system having high performances with a compact size may be formed with less expenses than that of using the glass lens.

It should be understood that exemplary embodiments described herein should be considered in a descriptive sense only and not for purposes of limitation. For example, it would be obvious to one of ordinary skill in the art that a blocking film may be used as a filter instead of the infrared blocking unit VI. While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A lens optical system comprising:
first to fifth lenses sequentially arranged along a light path between an object and an image sensor on which an image of the object is formed,
wherein the first lens has a positive refractive power,
the second lens has a negative refractive power,
the third lens has a negative refractive power,
the fourth lens has a positive refractive power,
the fifth lens has a negative refractive power, and
the lens optical system satisfies the following condition
60<FOV<90,
where FOV denotes a diagonal viewing angle of the lens optical system.

2. The lens optical system of claim 1, satisfying the following condition
0.5<AL/TTL<1.2,
where AL denotes a distance from an aperture to the image sensor, and TTL denotes an optical distance from a center of an incident surface of the first lens to the image sensor.

3. The lens optical system of claim 2, satisfying the following condition
0.5<TTL/ImgH<1.5,
where ImgH denotes a diagonal length of an effective pixel region of the image sensor.

4. The lens optical system of claim 1, satisfying the following condition
0.5<TTL/ImgH<1.5,
where ImgH denotes a diagonal length of an effective pixel region of the image sensor.

5. The lens optical system of claim 1, wherein an incident surface of the first lens is convex toward the object and an exit surface of the first lens is flat.

6. The lens optical system of claim 5, wherein at least one of the first to fifth lenses is an aspheric lens.

7. The lens optical system of claim 1, wherein at least one of the first to fifth lenses is an aspheric lens.

8. The lens optical system of claim 1, wherein an incident surface of the fifth lens has one or more inflection points from a center portion to an edge.

9. The lens optical system of claim 1, wherein one of an incident surface and an exit surface of at least one of the first to fifth lenses is an aspherical surface.

10. The lens optical system of claim 9, wherein an incident surface and an exit surface of each of the second to fifth lenses are aspherical surfaces.

11. The lens optical system of claim 1, wherein the aperture is disposed between the object and the first lens.

12. The lens optical system of claim 1, further comprising an infrared ray blocking unit between the fifth lens and the image sensor.

13. The lens optical system of claim 1, wherein at least one of the first to fifth lenses is a plastic lens.

14. A lens optical system comprising a first lens, a second lens, a third lens, and a fourth lens sequentially arranged between an object and an image sensor on which an image of the object is formed from the object side, and an aperture disposed between the object and the first lens,
wherein the first to fifth lenses respectively have positive, negative, negative, positive, and negative refractive powers, and the lens optical system satisfies at least one of following Conditions 1 to 3,
60<FOV<90, <Condition 1>
where FOV denotes a diagonal viewing angle of the lens optical system,
0.5<AL/TTL<1.2, <Condition 2>
where AL denotes a distance from the aperture to the image sensor, and TTL denotes an optical distance from a center of an incident surface of the first lens to the image sensor,
0.5<TTL/ImgH<1.5, <Condition 3>
where ImgH denotes a diagonal length of an effective pixel region of the image sensor.

15. The lens optical system of claim 14, wherein the first to fifth lenses comprise aspheric lenses.

16. The lens optical system of claim 14, wherein an incident surface of the first lens is convex toward the object, an exit surface of the first lens is flat, and an incident surface of the fifth lens has at least one inflection point.

17. The lens optical system of claim 14, wherein the aperture is disposed between the object and the first lens.
